(19) United States
(12) Patent Application Publication
(10) Pub. No.: US 2007/0039363 A1
(43) Pub. Date: Feb. 22, 2007

(54) System for industrial production of fertilizer by progressive digestion process

(76) Inventor: Dragan Mirkev Macura, Morgan Hill, CA (US)

Correspondence Address: Lorraine M. Donaldson, #283, 2658 Del Mar Heights Road, Del Mar, CA, 92014, US

(21) Appl. No.: 11/504,576

(22) Filed: Aug. 15, 2006

Related U.S. Application Data
(60) Provisional application No. 60/709,245, filed on Aug. 17, 2005.

(51) Int. Cl. C05D 9/02

(52) U.S. Cl. 71/1

(57) ABSTRACT

A system for industrial production of fertilizer by a progressive digestion process whereby organic matter is digested by optimizing, under controlled conditions, the natural digestive process indigenous to any degrading organic material. The organic input is conveyed through an array of vessels following a sequence of controlled mesophilic and thermophilic digestion steps such that each step facilitates the digestion of certain component of the incoming organic material. The last stage is carried out at a thermophilic temperature to inactivate any remaining vegetative cells of pathogenic microorganisms in the mixture, while supporting the growth of soil beneficial, non-pathogenic, thermophilic microorganisms. The resulting product is a dark, malodor and pathogen free, biologically active, fully digested and shelf stable liquid organic fertilizer.

### PRIORITY CLAIMED

Applicant claims priority to a previously filed Provisional Patent Application Ser. No. 60/709,245, filed 08/17/245.

### BACKGROUND OF THE INVENTION

1. Field of the Invention

The invention relates to system for industrial production of fertilizer.

2. Description of Related Art

Previous systems for producing fertilizer commonly convert organic inputs consisting of a single type of organic material, such as vegetable or animal matter into a fertilizer product. The organic input is stored in a container and may undergo a separation step to isolate the liquid or the solid in the input material and is allowed to ferment to produce a fertilizer containing certain nutrients, depending on the intended use of the fertilizer.

Examples of fertilizer production combining different organic input types can be found in U.S. Pat. No. 6,464,875 of Woodruff and U.S. Pat. No. 6,273,927 of Yang. The method of Woodruff treats food, animal, vegetable byproducts, which are degradable anaerobically, through four primary stages, namely 1) an anaerobic digestion stage, 2) a liquid-solids separation stage, 3) an ammonia removal and recovery stage, and 4) a solids processing stage. The resulting solid product is dewatered and may be granulated or formed into pellets. Yang discloses a method of manufacturing a liquid fertilizer made from organic wastes such as food wastes, human excrements, animal excrements, slaughterhouse waste, henhouse waste, fish and shellfish wastes, vegetable wastes and agricultural wastes, wherein a combination of organic wastes, from those previously listed, are gathered according to the type thereof, crushed or mixed to be processed into good state for treating, and then the mixture is put into a treating tank and reacted by a natural digestant, therefore, the toxicity of the organic wastes is neutralized; the organic wastes are sterilized; and the odor of the organic wastes is removed. Additional examples may be found in U.S. Pat. No. 5,782,950 of Kanitz et al. and U.S. Pat. No. 4,400,195 of Rijkens.

However, these prior methods process the mixture in a single digestion step failing to account for the different conditions needed for digesting each component which optimizes the quality of the resulting product.

The present invention presents a system in which the mixture is conveyed through an array of mesophilic and thermophilic digestion vessels following a sequence designed to optimize the digestion of each component of the mixture thereby producing a fertilizer of predetermined characteristics.

Another benefit of the present invention is the capacity to reproduce a standard of product quality for industrial production of a shelf-stable, mal-odor free and pathogen-free liquid fertilizer.

### BRIEF SUMMARY OF THE INVENTION

The present invention comprises, as illustrated in FIG. 1, a tank for receiving a mixture of organic input materials and blending said mixture; a second tank for performing a controlled primary mesophilic digestion of said mixture; a tank for performing a controlled secondary mesophilic digestion of said mixture; a tank for performing a controlled thermophilic digestion of said mixture; a centrifuge; a filter; and storage containers with means for aerating the resulting filtered material for a predetermined period of time to thereby produce a fertilizer product of liquid, mal-odor free, pathogen-free and shelf stable form.

### BRIEF DESCRIPTION OF THE DRAWINGS

The present invention is described in detail below with reference to the drawings in which:

FIG. 1 shows systematic illustration of the system of the present invention.

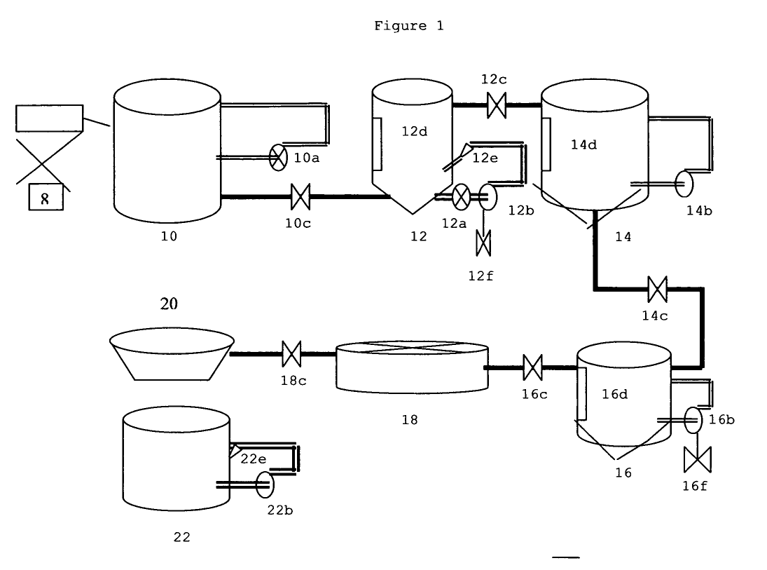

FIG. 2 shows a flowchart of the preferred method of the utilizing the system of present invention.

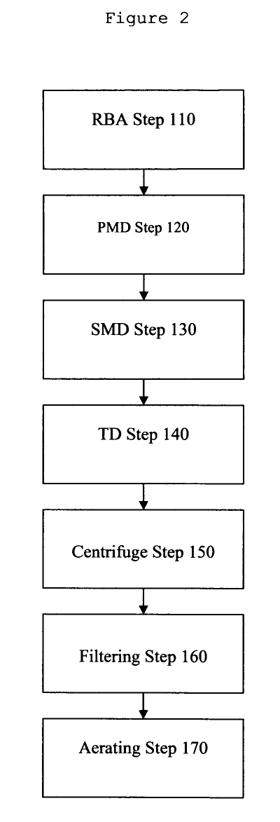

### DETAILED DESCRIPTION OF THE PREFERRED EMBODIMENTS

The following is a description of the system for industrial production of fertilizer, in reference to the preferred embodiment in which a progressive digestion process is utilized for the production of fertilizer.

The starting materials for the process form a mixture of organic inputs, including digestive enzyme source (DES) inputs, pH adjustment inputs and nutrient sources (NS).

Digestive enzyme source inputs may be waste materials such as fish processing wastes that contain fish and crab guts with all the digestive enzymes for animal-based proteins; malt barley plant wastes that carry digestive enzymes for starch-based NS inputs. Poultry slaughterhouse wastes with gizzard and poultry intestines carry enzymes for both plant and animal-based protein digestion. Rumen contents from sheep and beef slaughterhouses are good source of cellulytic microbes and enzymes that digest cellulose-containing plant materials such as wood chips and sawdust. Starch-digesting DES can be prepared by sprouting feed barley or other low-cost grains, grinding them, and adding to starch rich NS such as pasta or bakery wastes. The DES materials provide the digestive enzymes that augment the microbial digestion, the other major degradative process in PDP. It is important to match proper DES with the prevailing NS to facilitate complete digestion of waste organic inputs within the minimum length of time. After PDP is complete, the digestive enzymes from DES end up in soil where they contribute to additional organic matter degradation. This in turn contributes to the nutrient assimilation by the crops.

Examples of pH adjustment inputs are waste organic materials such as waste organic acids (citric, acetic, lactic, malic, etc.) from their respective manufacturing plants. Or, they can be acidic wastes from operations such as juice extracting plants, fruit processing or resulting fruit pumice. These materials are used to keep the pH of the fermentation down to reduce ammonia evaporation and foam creation.

Nutrient source inputs vary in nutrient content according to the origin of the organic material. Thus, slaughterhouse wastes have more protein and bones than pasta processing plant wastes. By comparison, the pasta waste has more starch than slaughterhouse waste. Both are good PDP inputs since they both support good microbial growth and are easily digested. The microbial biomass also contributes to the overall nutrition (fertilizer value) of the final product, as the microbes also become plant food at the end of their life cycle.

The decision about the PDP organic inputs can be made on the basis of available organic wastes, or on the basis of the desired nutritional value of the final product. If it is made on the basis of available inputs, then the nutritional value of the final product is varied. If it is based on the nutritional value of the final product then the combination of the inputs varies with each change of the available supply.

This invention claims the unique combination of organic inputs and environmental conditions created by a succession of digestion vessels to obtain a substantially digested, liquid, pathogen-free and malodor-free, fermented organic soil amendment (FOSA) or liquid organic fertilizer (LOF) that has been thermophilically treated for pathogen elimination and shelf stability.

Progressive Digestion Process

Step 110—Receiving, Blending and Adjustments (RBA)

All starting materials in PDP are added to an RBA tank 10 equipped with re-circulating chopper pump 10a. It is strategically located to receive both liquid and ground solid materials such as slaughterhouse bones and hides, or animal carcasses from confined animal feeding operations (CAFO) mortalities. Solid materials are ground by using a hammer mill (8) adjusted to less than 1 inch particle size.

After receiving pre-determined amount of both liquid and solid inputs, the materials are re-circulated with the re-circulation chopper pump 10a that further reduces the particle size and homogenizes the slurry in the RBA tank 10. A sample is taken at this stage to measure pH of the slurry. If needed, pH is adjusted by adding acidic wastes to reduce pH to less than 6. As soon as the material in RBA tank 10 is easily pumpable, it is transferred to the primary mesophilic digester (PMD) 12 through a fluid connector 10c. Alternatively, the contents of RBA tank 10 may be left undisturbed for 1 to 2 days to initiate enzymatic degradation under anaerobic conditions.

Then, they are pumped to PMD 12 through the fluid connector 10c.

Step 120—Primary Mesophilic Digestion (PMD)

The PMD tank 12 is an upright-standing, cone-bottom, digestion vessel equipped with an all-in-one mixing and aeration system. Both, mixing and aeration are accomplished by installing a venturie 12e directly into the pipe of an external re-circulation system. The liquid medium is constantly pumped from the bottom of the vessel, through the venturie 12e and discharged back into the tank 12 in close proximity to the suction port. The suction side of the pump 12b is connected about 2 feet above the lowest point of the PMD cone, with an inlet pipe that is at least one inch wider than the discharge pipe. The discharge side of the pump 12b is connected through the discharge pipe to the discharge nozzle into the lower half of the digestion vessel, preferably just above the cone of the digestion vessel. The discharge nozzle is a 45°-angled reduction nozzle that reduces the inside diameter of the pipe by 25%. The discharge nozzle is pointed downward and to one side away from the intake pipe of the re-circulating pump 12b. The pump 12b is connected to a variable speed drive 12f. Its speed is adjustable such that it causes gentle mixing inside the tank at its low speed setting, or a very vigorous mixing at the high end of the pump speed. Oxygenated liquid medium is discharged at the bottom of the tank, thus experiencing maximum oxygen contact with liquid medium on its way out of the vessel, and thereby facilitating maximum oxygen dissolution. The liquid discharge into the vessel accomplishes both, the liquid mixing and oxygenation of the medium. The PMD tank 12 is thermally insulated with about 1-inch wall of foam insulation. After the tank is filled with fresh material the pump 12b is turned on at a low speed until the fermentation starts to take hold as indicated by the temperature increase. Then, the pump 12b is ramped up slowly by the variable speed drive 12f until it reaches the maximum speed and the maximum rate of aeration. Temperature, pH and oxidation-reduction potential (ORP) are monitored for process control illustrated, in general, as physical parameter monitoring instrumentation 12d. Also, a foam detector in said monitoring instrumentation 12d is turned on to monitor the foam level on the liquid surface. In addition, samples are taken for digestion analysis by monitoring the amount of free amino acids (Ninhydrin test) and undigested starch (Iodine test) in the medium. The insulation foam thickness on this tank is critical to holding the maximum temperature at 38° C.

After the digestion has leveled off in PMD (2-5 days), the medium is pumped to the secondary mesophilic digester (SMD) through a 3″ pipe 12c, for further processing.

Step 130—Secondary Mesophilic Digestion (SMD)

The material coming from the PMD tank 12 is usually close to 38° C. It is a partially digested liquid. In the SMD tank 14, it continues the digestion process, except the digestion takes place at a higher temperature. To accomplish this, SMD vessel 14 is insulated with about 2-inch thick wall of insulation foam. All other process parameter monitoring instrumentation 14d is the same as that in PMD. With this foam thickness the final temperature reached in the vessel is 50° C. The digestion is monitored throughout fermentation by taking samples daily and performing Ninhydrin and starch tests. After the digestion levels off, the SMD contents are pumped into the thermophilic digestion (TD) tank 16 through a 3″ pipe 14c.

Step 140—Thermophilic Digestion (TD)

The material coming from SMD tank 14 is usually close to 50° C. It is even more digested than before it was moved to the SMD tank 14. In the TD tank 16, the digestion continues. However, this tank 16 is insulated with 3.5-inch thick layer of insulation foam. Thus, the maximum temperature reached in this tank exceeds 65° C. After moving the material from SMD tank, the pump 16b in TD tank is ramped up slowly by a variable speed drive 16f to raise the temperature to 65° C. over the next 2 days. It is kept at 65° C. for 3 days to assure pathogen elimination.

Other parameters monitored in this processing tank are ORP, pH, enzyme activity and microbial activity. Similar to the vessels for mesophylic digestion, these parameters are monitored by monitoring instrumentation 16d provided in the TD tank 16. It is important to monitor the microbial activity to make sure that viable microbial cells are in abundance in the final product. Enzyme activity in the final product shows what enzyme activity can be expected to be added to the soil by adding fresh FOSA. This activity is monitored throughout the shelf life of the product to see if the enzyme activity of the product increases or decreases with storage.

Final pH of the product is preferred to be less than 4.5 as this pH prevents proliferation of pathogenic micro-organisms. However, after the heat treatment process, no unprocessed materials can be added to the final product due to the possibility of microbial contamination. Therefore, last pH adjustment in the process should be done in the SMD tank 14, before transfer to TD tank 16.

The product is then pumped through a 3″ pipe 16c to a centrifugation device 18, as described below.

Step 150—Centrifugation

After thermophilic fermentation process is complete, the product is centrifuged with a horizontal decanter centrifuge 18, or any other solids separator. This assures solids separation and minimizes spray nozzle plugging in the spraying equipment used for dispensing the fertilizer product.

Step 160—Filtration

After centrifugation, the product is passed through a fluid connector 18c to a vibrating 200-mesh screen 20 to separate possible remaining light solids in the product and make it drip-tape compatible.

Feed rate of the fluid connector 18c is monitored to assure proper filtration and maximum throughput. The product is poured into one of a number of closed storage tanks 22 outfitted with valves 22b suitable for product recirculation.

Step 170—Aeration

The product is circulated through a pump 22b and a venturie 22e for 1 hour every week to aerate and mix it. The size of the pump and the venturie are coordinated with the size and volume of the storage tank.

As described above, the resulting product is a shelf-stable, mal-odor and pathogen free, liquid fertilizer.

Moreover, the system can also be employed for treatment of wastes such as the segregated municipal food wastes. In this case, both the solid and the liquid fraction are thermophilically treated at the end of PDP process. Solid fraction is a very good adjunct to the windrow composting piles, while the liquid fraction can be used as a soil amendment, or as a stock for higher nutritional value fertilizer by adding more organic nutrients and repeating PDP.

While the present invention has been shown and described herein in what are conceived to be the most practical and preferred embodiments, it is recognized that departures, modifications, adaptations, variations and alterations in the described method may be made and will be apparent to those skilled in the art of the foregoing description which does not depart from the spirit and scope of the invention which is therefore not to be limited to the details herein.

For this reason, such changes are desired to be included within the scope of the appended claims. The descriptive manner which is employed for setting forth the embodiments should be interpreted as illustrative but not limitative of the full scope of the claims which embrace any and all equivalents thereto.

What is claimed is

1. A system for producing a fertilizer by a progressive digestion process, said system comprising:
a first tank for receiving a mixture of organic inputs, said tank including means for re-circulating and chopping said mixture;
a second tank with about 1.25-inch thick insulation foam receiving said mixture from said first tank for performing primary mesophilic digestion of said mixture, said second tank comprising:
means for re-circulating said mixture;
means for monitoring a mixture temperature during mesophilic digestion;
at least one means for monitoring an additional physical parameter of said mixture during mesophilic digestion; and
means for controlling said means for re-circulating said mixture, said controlling means communicating with said means for re-circulating said mixture, said means for monitoring a mixture temperature during mesophilic digestion and said at least one means for monitoring an additional physical parameter of said mixture during mesophilic digestion within said second tank;
a vessel receiving said mixture from said second tank for performing secondary mesophilic digestion of said mixture, said vessel comprising:
about 2 inch thick insulation foam;
means for monitoring a mixture temperature during secondary mesophilic digestion of said mixture; and
means for monitoring at least one additional physical parameter of said mixture during secondary mesophilic digestion;
a third tank with greater than 3.5-inch thick insulation foam receiving said mixture from said vessel for thermophilic digestion of said mixture, said third tank comprising:
means for re-circulating said mixture during thermophilic digestion;
means for monitoring a mixture temperature during thermophilic digestion of said mixture;
means for monitoring at least one additional physical parameter during thermophilic digestion of said mixture; and
means for controlling said means for re-circulating said mixture, said controlling means communicating with said means for re-circulating said mixture, said means for monitoring a mixture temperature during thermophilic digestion and said at least one means for monitoring an additional physical parameter of said mixture during thermophilic digestion within said third tank;
a centrifuge receiving said mixture from said third tank; and
means for filtering said mixture, said filtering means receiving said mixture from said centrifuge and being coupled to a storage tank which receives a resulting filtered mixture and includes a means for aerating said resulting filtered mixture to thereby produce a fertilizer product in liquid, mal-odor and pathogen free and shelf stable form.

2. The system of claim 1, wherein said at least one means for monitoring an additional physical parameter of said mixture during mesophilic digestion is one of the group consisting of pH value detector, oxidation-reduction potential detector and a foam level detector.

3. The system of claim 1, wherein said at least one means for monitoring an additional physical parameter of said mixture during mesophilic digestion comprises a pH value detector, oxidation-reduction potential detector and a foam level detector.

4. The system of claim 1, wherein said at least one means for monitoring an additional physical parameter of said mixture during said step of thermophilic digestion comprises a oxidation-reduction potential detector, a pH value detector, an enzyme activity detector and a microbial activity detection.

5. A fertilizer product in liquid, mal-odor and pathogen free and shelf stable form, produced by a progressive digestion process comprising:
a starting mixture of organic input material, said mixture being added into a first tank, wherein the mixture is re-circulated and a pH value of said mixture is adjusted to a predetermined pH value;
said mixture being then transferred to a second tank for primary mesophilic digestion, wherein said mixture is re-circulated until fermentation begins as indicated by a temperature increase, during which step the mixture temperature and at least one other physical parameters of said mixture is monitored to determine when the mixture temperature has reached a first predetermined maximum value; and controlling the recirculation of the mixture to maintain the mixture temperature at said first predetermined maximum value for a predetermined period of time;
said mixture being then transferred into a vessel for secondary mesophilic digestion, wherein said mixture temperature and at least one other physical parameters of said mixture to monitor the fermentation process until the mixture temperature reaches a second predetermined maximum value;
said mixture is then transferred into a third tank for thermophilic digestion, including, wherein the mixture is re-circulated and the mixture temperature and at least one additional physical parameter is monitored to monitor the fermentation process until the mixture temperature reaches a third predetermined maximum value, and the mixture temperature is maintained at said third predetermined maximum value for a predetermined period of time by controlling said step of re-circulating the mixture;
said mixture is then transferred to a centrifuge; and after centrifugation, filtering said mixture and storing a resulting filtered material into a storage means comprising aerating said stored material during a predetermined period of time for a resulting fertilizer product in liquid, mal-odor free and shelf stable form.

6. The fertilizer product of claim 6, wherein said mixture of organic input materials comprises at least one of the group consisting of animal manures, food industry wastes, sorted municipal food wastes, vegetable processing leftovers, grass clippings and combinations thereof.

7. The fertilizer product of claim 6, wherein said predetermined pH value is less than 6.

8. The fertilizer product of claim 6, wherein said at least one other physical parameter monitored during said step of primary mesophilic digestion is one of the group consisting of pH value, oxidation-reduction potential, foam level.

9. The fertilizer product of claim 9, wherein said step of primary mesophilic digestion further comprises sampling said mixture to determine an amount of free amino acids and an amount of undigested starch.

10. The fertilizer product of claim 6, wherein said step of secondary mesophilic digestion further comprises the step of sampling said mixture to determine an amount of free amino acids and an amount of undigested starch.

11. The fertilizer product of claim 6, wherein said step of secondary mesophilic digestion of said mixture further comprises a second step of adjusting the pH value of the mixture.

12. The fertilizer product of claim 6, wherein said at least one other parameter monitored during said step of thermophilic digestion comprises one of the group consisting of oxidation-reduction potential, pH value, enzyme activity, microbial activity, and combinations thereof.

13. The fertilizer product of claim 6, wherein said at least one other parameter monitored during said step of thermophilic digestion comprises oxidation-reduction potential, pH value, enzyme activity, and microbial activity.

14. The fertilizer product of claim 6, wherein the first predetermined maximum temperature value is about 38° C.

15. The fertilizer product of claim 6, wherein said second predetermined maximum temperature value is about 50° C.

16. The fertilizer product of claim 6, wherein said third predetermined maximum temperature value is about 65° C.
